(19) United States
(12) Patent Application Publication
(10) Pub. No.: US 2009/0034650 A1
(43) Pub. Date: Feb. 5, 2009

(54) SEMICONDUCTOR INTEGRATED CIRCUIT AND METHOD FOR OPERATING ULTRA WIDE BAND-IMPULSE RADIO-TRANSMITTER

(76) Inventors: Takayasu NORIMATSU, Kokubunji (JP); Masayuki Miyazaki, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/181,333

(22) Filed: Jul. 29, 2008

(30) Foreign Application Priority Data
Jul. 31, 2007 (JP) 2007-198252

(51) Int. Cl. H04L 27/00

(52) U.S. Cl. 375/295

(57) ABSTRACT

Provided is a semiconductor integrated circuit, in which a transmit pulse having an impulse waveform is produced using pull-up and pull-down currents of the charge pumps of pattern-generating cells of the pattern generator. During the first calibrating operation of semiconductor integrated circuit, the variation in amplitude of the transmit pulse is detected. At least one of pull-up and pull-down currents of the charge pumps is controlled according to a first calibration control signal responsive to the result of detection of the amplitude. During the second calibrating operation, the fluctuation in DC level just after producing of a repeat pulse of the transmit pulse is also detected. Imbalance between the pull-up and pull-down currents of the charge pumps are lowered according to a second calibration control signal responsive to the result of detection of the DC level fluctuation.

### CLAIM OF PRIORITY

The Present application claims priority from Japanese application JP 2007-198252 filed on Jul. 31, 2007, the content of which is hereby incorporated by reference into this application.

### FIELD OF THE INVENTION

The present invention relates to a semiconductor integrated circuit and a method for operating an ultra wide band-impulse radio-transmitter. Particularly, it relates to a technique suitable to achieve characteristics of a semiconductor integrated circuit conforming to given regulations with a high production yield or high stability.

### BACKGROUND OF THE INVENTION

A ubiquitous age where familiar pieces of electric and electronic equipment are in communication with one another, and any and all pieces of such equipment are linked to one network is dawning. The materialization of such ubiquitous age has been a goal. Short-range wireless communication is sufficient for familiar pieces of electric and electronic equipment to communicate mutually. Therefore, it is expected that realization of ubiquitous society leads to expansion of WPAN (Wireless Personal Area Network) market. As one of WPAN communication systems, UWB (Ultra Wide Band) system has been in the spotlight.

UWB system has the advantage of being low in power consumption per communication rate. In other words, UWB system consumes a small amount of energy in sending a unit data. On this account, UWB system is suitable for communication by a system requiring long-life batteries such as a sensor network, which is one of network systems of the ubiquitous age. As a communication system to materialize such ubiquitous-age network, a low-speed UWB system has attracted attention. An IR system is suitable for such low-speed UWB system (IR: Impulse Radio). The voltage and current waveforms of a transmit-impulse signal emitted by an ultra wide impulse transmitter last for a very short time solely or intermittently, and this type of transmitter does not use a stationary carrier signal as used in a typical RF transmitter. Therefore, the low-speed UWB system enables an ultralow power-consuming operation.

In the past, in the patent document, Japanese Patent No. 2,790,883 is disclosed a system in which the amplitude of a triangular wave signal generated by a triangular wave generator used as a pulse-width modulation unit of e.g. a switched mode servo amplifier is controlled by negative feedback.

Further, a nonpatent document presented by Enrico Temporiti et al., “A 700-kHz Bandwidth ΣΔ Fractional Synthesizer With Spurs Compensation and Linearization Techniques for WCDMA Applications”, IEEE Journal of Solid-States Circuits, Vol. 39, No. 9, September 2004, pp. 1446-1454, hereinafter referred to as “Nonpatent Document 1”, contains the description on control of the mismatch between PMOS and NMOS current sources of a charge pump (CP) for the purpose of improving the linearity of the phase-frequency detector (PFD) and charge pump (CP) of a fractional PLL synthesizer. Now, it is noted that PMOS stands for a p-channel MOS transistor and NMOS is for an n-channel MOS transistor.

Further, in another nonpatent document presented by Takayasu Norimatsu et al., “A UWB-IR Transmitter With Digitally Controlled pulse Generator”, IEEE Journal of Solid-States Circuits, Vol. 42, No. 6, JUNE 2007, pp. 1300-1309, hereinafter referred to as “Nonpatent Document 2”, there is the description about an ultra wide band-impulse radio-transmitter which digitally controls the form of a transmit pulse to meet the spectral mask regulations defined by Federal Communications Commission (FCC). The transmitter includes a timing controller, a pulse generator, and a power amplifier. When supplied with a base band signal, the timing controller produces control signals for a pair of pattern generators of the pulse generator and for the power amplifier. When supplied with a clock signal, a delayed locked loop (DLL) of the pulse generator produces delay signals different in timing, which are supplied to the pair of pattern generators. Each pattern generator includes a plurality of pattern-generating cells (PG cell) producing triangular waves when supplied with delay signals. The amplitude of the triangular waves produced by the pattern-generating cells is proportional to the gate size of PMOS and NMOS of the charge pump. Output signals of the pair of pattern generators are amplified by the power amplifier, and then subjected to subtraction by the balun at an output, whereby a final transmit pulse is formed.

### SUMMARY OF THE INVENTION

The digital control system as described in Nonpatent Document 2 enables formation of a transmit pulse according to the ultra wide band impulse (UWB-IR) communication system.

However, after a study of the digital control system as stated in Nonpatent Document 2, the inventors clearly showed the problem that the digital control system cannot satisfy the regulations including FCC spectral mask regulations with a high production yield or high stability when a UWB-IR transmitter is materialized using a semiconductor integrated circuit. Specifically, because of the variation of characteristics of PMOS and NMOS formed in the chip of a semiconductor integrated circuit or their temperature dependence, the digital control system as stated in Nonpatent Document 2 cannot meet the FCC regulations concerning a spectral mask and others.

FIG. 1 is a diagram showing an ultra wide band-impulse radio-transmitter, which has been studied by the inventors prior to the invention. The transmitter shown in FIG. 1 includes a semiconductor integrated circuit 1, a pair of output matching circuits 2 and 3, and a balun 4. The semiconductor integrated circuit 1 includes a timing controller 10, a pulse generator 11, and a power amplifier 12. The pulse generator 11 includes a delay locked loop (DLL) 110, and a pair of pattern generators 111 and 112.

The timing controller 10 of the semiconductor integrated circuit 1 is supplied with a transmit digital baseband signal BB from a baseband LSI (not shown). The timing controller 10 produces control signals PACLK and /PACLK for the power amplifier 12, and a control signal PGENB for the pair of pattern generators 111 and 112 of the pulse generator 11. The delay locked loop (DLL) 110 of the pulse generator 11 is supplied with a clock signal CLK. The delay locked loop 110 produces delay signals different in timing, which are supplied to the pair of pattern generators 111 and 112. The pattern generators 111 and 112 each include a plurality of pattern-generating cells (PG cell). When supplied with delay signals, the pattern-generating cells produce triangular wave pulses. The amplitude of the triangular wave pulse produced by each pattern-generating cell is proportional to the gate size of PMOS and NMOS of the charge pump. The output signals PLSP and PLSN from the paired pattern generators 111 and 112 are amplified by the power amplifier 12. The output signals of the power amplifier 12 are passed through the output matching circuits 2 and 3 and then supplied to the balun 4 in an output portion of the transmitter. In the balun 4, the output signals of the power amplifier 12 undergo a subtraction, and thus a final transmit pulse OUT is formed.

FIG. 2 is a diagram showing waveforms observed in some portions for explaining operations of the transmitter shown in FIG. 1. At the time when a pair of UWB-IR transmit impulses OUT is produced, the clock signal CLK is brought to High level “1”. Then, to enable pattern generation by the paired pattern generators 111 and 112 of the pulse generator 11, the control signal PGENB is also brought to High level “1”. Also, the control signal PACLK is brought to High level “1” to enable amplification by the power amplifier 12.

The delay locked loop (DLL) 110 of the pulse generator 11 produces fifteen delay signals different in timing in response to the clock signal CLK. As for the waveform drawn in the first half portion of FIG. 2, it is assumed that the transmit digital baseband signal BB supplied by the baseband LSI is at e.g. High level “1”. According to the level of the transmit digital baseband signal BB supplied by the timing controller 10, one pattern generator 111 produces a repeat pulse signal PLSP having seven peaks at the times T1, T3, T5, T7, T9, T11, T13 ranked at even ordinal numbers in a total of fifteen times T0 to T14. The other pattern generator 112 produces a repeat pulse signal PLSN having six peaks at the times T2, T4, T6, T8, T10, T12 ranked at the odd ordinal numbers in the fifteen times T0 to T14.

As for the waveform drawn in the latter half portion of FIG. 2, it is assumed that the transmit digital baseband signal BB supplied by the baseband LSI is at e.g. Low level “0”. According to the level of the transmit digital baseband signal BB supplied by the timing controller 10, the one pattern generator 111 produces a repeat pulse signal PLSP having six peaks at the times T2, T4, T6, T8, T10, T12 ranked at odd ordinal numbers in the fifteen times T0 to T14. The other pattern generator 112 produces a repeat pulse signal PLSN having seven peaks at the times T1, T3, T5, T7, T9, T11, T13 ranked at even ordinal numbers in the fifteen times T0 to T14.

The output signals PLSP and PLSN of the paired pattern generators 111 and 112 are amplified by the power amplifier 12. The output signals of the power amplifier 12 are passed through the output matching circuits 2 and 3 and supplied to the balun 4 at the output. In the balun 4, the output signals of the power amplifier 12 undergo a subtraction, and thus a final transmit pulse OUT is formed.

FIG. 3A is a diagram showing the variation in characteristics of a semiconductor integrated circuit of the transmitter as shown by FIG. 1 and the change in the waveform of a UWB-IR communications system's transmit pulse owing to a temperature fluctuation, and FIG. 3B is a diagram showing the frequency characteristics of the transmit power.

A transmit pulse according to UWB-IR communications system as shown in FIG. 3A has the following problems. The first problem is, as to the waveform 102 smaller in amplitude than the waveform 100 fitting a design value, the communication distance within which communication is practicable is shorter. The second problem is that the waveform 101 larger in amplitude than the waveform 100 cannot meet the requirements of the FCC spectral mask regulations and others.

FIG. 3B presents transmit power-frequency characteristic curves corresponding to the waveforms 100, 101 and 102 shown in FIG. 3A. In FIG. 3B, the thin broken line 106 represents a characteristic curve conforming to the requirements under the FCC spectral mask regulations, and the dotted line 103 corresponds to the waveform 100 fitting a design value shown in FIG. 3A. The solid line 104 shown in FIG. 3B corresponds to the waveform 101 larger in amplitude than the waveform conforming to the design value shown in FIG. 3A. The broken line 105 corresponds to the waveform 102 smaller in amplitude than the waveform conforming to the design value shown in FIG. 3A. It becomes a problem that the transmit power represented by the characteristic curve 104 corresponding to the waveform 101 having a larger amplitude as shown in FIG. 3A exceeds the characteristic line 106 corresponding to the spectral mask for two segments thereof as shown in FIG. 3B.

FIG. 4A is a diagram showing the variation in characteristics of a semiconductor integrated circuit of the transmitter as shown by FIG. 1 or the change in the waveform of a UWB-IR communications system's transmit pulse owing to a temperature fluctuation, and FIG. 4B is a diagram showing the frequency characteristics of the transmit power.

The repeat pulse output signals PLSP and PLSN of the paired pattern generators 111 and 112 of the pulse generator 11 shown in FIG. 1 create no problem as long as the fluctuation in DC level is negligible as shown by the dotted lines 203 and 204 in FIG. 4A. However, the repeat pulse output signals PLSP and PLSN can cause a problem when the DC level fluctuation, e.g. a decrease of DC level, is too large to ignore as shown by the solid lines 205 and 206 in FIG. 4A. The repeat pulse output signals PLSP and PLSN of the paired pattern generators 111 and 112 are supplied to the power amplifier 12, the output matching circuits 2 and 3, and the balun 4. In the balun 4, the subtraction of output signals from the power amplifier 12 is performed and thus the final transmit pulse OUT is formed. Also, the final transmit pulse OUT creates no problem as long as the fluctuation in DC level is negligible as shown by the dotted line 200 in FIG. 4A. However, the final transmit pulse OUT presents a problem when the DC level fluctuation 202, e.g. a decrease of DC level, is too large to ignore as shown by the solid line 201 in FIG. 4A.

The DC level fluctuation 202 to be reckoned with like this, which is contained in the UWB-IR communications system's transmit pulse OUT, can cause unwanted radiation at lower RF transmit frequencies. In other words, it becomes a problem that as shown by the broken line 208 in FIG. 4B, radiated power owing to unwanted radiation exceeds the transmit power specified by the characteristic line 106 corresponding to the spectral mask at lower RF transmit frequencies ranging about 1 from 3 GHz.

Hence, the inventors elucidated the mechanism of occurrence of such problems. First, the mechanism of occurrence of amplitude fluctuations as shown by the waveforms 100, 101 and 102 of the transmit pulse in FIG. 3A is as follows. That is, the amplitude fluctuations result from the fluctuation of one of PMOS pull-up current I_{PU} and NMOS pull-down current I_{PD} of charge pumps of pattern-generating cells of the pattern generators 111 and 112 of the pulse generator 11 shown in FIG. 1. (The one current is e.g. the pull-up current.)

Second, it is found out that the DC level fluctuation 202 as shown in FIG. 4A is attributed to the imbalance of one of PMOS pull-up current I_{PU} and NMOS pull-down current IPD of charge pumps of the pattern-generating cells (PG cell) with the other. (The one current is e.g. the pull-down current.)

The invention was made in consideration of the result of study by the inventors prior to the invention as described above. Therefore, it an object of the invention to provide an ultra wide band-impulse radio-transmitter which can achieve characteristics of a semiconductor integrated circuit conforming to predetermined regulations with a high production yield or high stability.

The above and other objects and novel features hereof will be apparent from the description hereof and the accompanying drawings.

Of embodiments hereby disclosed, the outline of representative one is as follows.

A semiconductor integrated circuit incorporated in an ultra wide band-impulse radio-transmitter, which is a representative embodiment has: a generator (111) including pattern-generating cells (300) for producing a transmit pulse (OUT); and a calibration unit (301, CAL) for calibrating the amplitude of the transmit pulse (OUT) and the fluctuation in the DC level thereof. (See FIGS. 7 and 10.)

### BRIEF DESCRIPTION OF THE DRAWINGS

FIG. 1 is a diagram showing an ultra wide band-impulse radio-transmitter, which has been studied by the inventors prior to the invention;

FIG. 2 is a diagram showing waveforms in some portions for explaining operations of the transmitter shown in FIG. 1;

FIG. 3A is a diagram showing the variation in characteristics of a semiconductor integrated circuit of the transmitter as shown by FIG. 1 and the change in the waveform of a UWB-IR communications system's transmit pulse owing to a temperature fluctuation;

FIG. 3B is a diagram showing the frequency characteristics of the transmit power;

FIG. 4A is a diagram showing the variation in characteristics of a semiconductor integrated circuit of the transmitter as shown by FIG. 1 or the change in the waveform of a UWB-IR communications system's transmit pulse owing to a temperature fluctuation;

FIG. 4B is a diagram showing the frequency characteristics of the transmit power;

FIG. 5 is a diagram showing an ultra wide band-impulse radio-transmitter according to an embodiment of the invention;

FIG. 6 is a diagram for explaining a calibrating operation by a calibration unit shown in FIG. 5, which shows an internal circuit configuration of a pair of pattern generators, and the waveform of a repeat pulse signal;

FIG. 7 is a diagram showing configurations of a delay locked loop and the paired pattern generators in a pulse generator of the semiconductor integrated circuit of the UWB-IR transmitter shown in FIG. 5;

FIG. 8 is a diagram showing a configuration of pattern-generating cells of the paired pattern generators shown in FIG. 7;

FIGS. 9A and 9B are diagrams each showing a waveform of the pulse signal formed by the one pattern generator of the pulse generator according to the level of the transmit digital baseband signal;

FIG. 10 is a diagram showing a configuration of the calibration unit shown in FIG. 5 further in detail;

FIG. 11 is a diagram showing an example of configuration of the pattern-generating cell and the calibration unit for amplitude value control shown in FIG. 10 further in detail;

FIGS. 12A and 12B are waveform diagrams for explaining the calibrating operation for amplitude value control using the pattern-generating cell and calibration unit shown in FIG. 11;

FIG. 13 is a diagram showing a configuration of the calibration-bias circuit of the charge pump of the pattern-generating cell of FIG. 11;

FIG. 14 is a diagram showing a modification of the example of configuration of the pattern-generating cell and the calibration unit for amplitude value control shown in FIG. 11, in which the voltage comparator and the amplitude calibration reference voltage in the calibration unit of FIG. 11 are replaced with an analog-to-digital converter and reference voltage data respectively.

FIG. 15 is a diagram showing an example of configuration of the pattern-generating cell and the calibration unit for amplitude value control and DC level control shown in FIG. 10 further in detail;

FIGS. 16A and 16B are waveform diagrams for explaining an operation for DC level detection and calibration by the pattern-generating cell and the calibration unit shown in FIG. 15;

FIG. 17 is a diagram showing a modification of the example of configuration of the pattern-generating cell and the calibration unit for amplitude value control and DC level control shown in FIG. 15, in which the voltage comparator and the DC level calibration reference voltage in the calibration unit shown in FIG. 15 are replaced with an analog-to-digital converter and reference voltage data respectively;

FIG. 18 is a diagram showing a modification of the example of configuration of the pattern-generating cell and the calibration unit for amplitude value control and DC level control shown in FIG. 15, in which a counter and a control circuit are added to the output of the voltage comparator in the calibration unit shown in FIG. 15; and

FIG. 19 is a waveform diagram for explaining an operation for DC level detection and calibration by the pattern-generating cell and the calibration unit shown in FIG. 18.

### DETAILED DESCRIPTION OF THE PREFERRED EMBODIMENTS

### 1. Summary of the Preferred Embodiments

First, the preferred embodiments of the invention hereby disclosed will be outlined. Here, the reference numerals, characters or signs in parentheses for reference to the drawings just exemplify what the concepts of components referred to by the numerals, characters or signs contain.

[1] A semiconductor integrated circuit according to a preferred embodiment of the invention is incorporated in an ultra wide band-impulse radio-transmitter, which produces a transmit pulse (OUT) having an impulse waveform with predetermined amplitude values at times at an output terminal (303) during a transmitting operation.

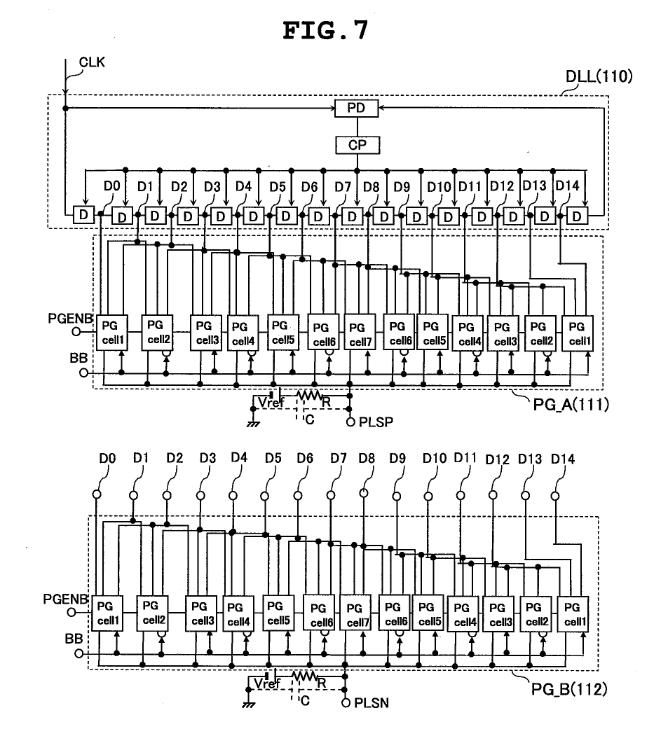

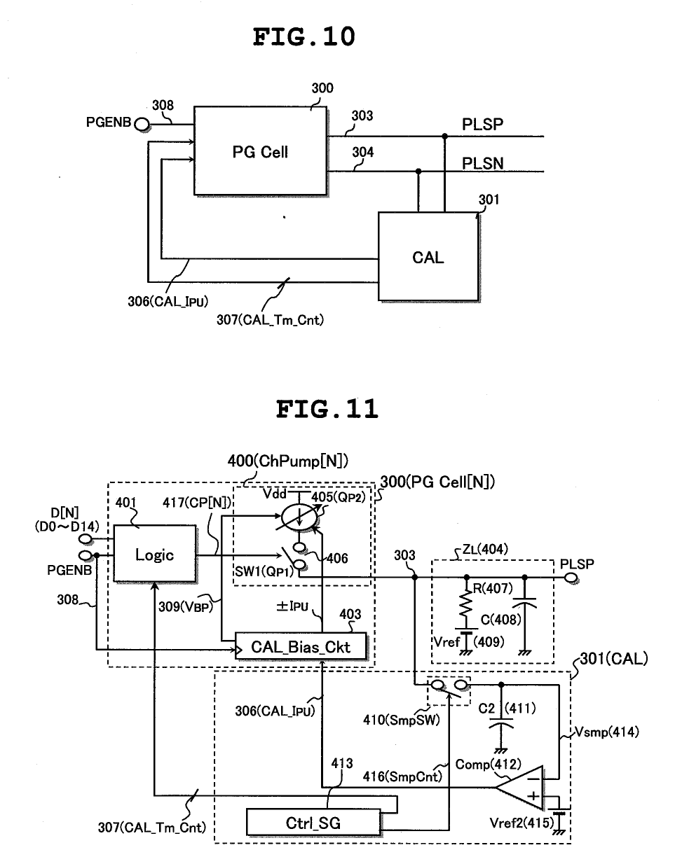

The semiconductor integrated circuit has: a generator (111) including a plurality of pattern-generating cells (300, PG Cell1-PG Cell7) for producing the transmit pulse (OUT); and a calibration unit (301, CAL) for calibrating the transmit pulse (OUT) in amplitude and DC level fluctuation (see FIGS. 7 and 10).

The plurality of pattern-generating cells each include: a pull-up variable constant-current transistor (Q_{P2}) for passing a pull-up current through the output terminal (303); and a pull-down variable constant-current transistor (Q_{N2}) for passing a pull-down current through the output terminal (303) (see FIG. 6).

The generator (111) includes a bias circuit (403, CAL_Bias_Ckt) for supplying a pull-up bias voltage (V_{BP}) and a pull-down bias voltage (V_{BN}) to the pull-up variable constant-current transistor and the pull-down variable constant-current transistor of the plurality of pattern-generating cells respectively (see FIG. 6).

The calibration unit (301, CAL) includes: a sampling circuit (410, 411) for sampling a voltage at the output terminal (303); and a control circuit (412, 700) for controlling the pull-up and pull-down bias voltages from the bias circuit in response to the output from the sampling circuit (see FIGS. 11 and 15).

At least one of the plurality of pattern-generating cells of the generator produces a pulse amplitude (PLSP) at the output terminal (303) during a first calibrating operation.

The sampling circuit of the calibration unit samples the pulse amplitude at the output terminal during the first calibrating operation.

The control circuit of the calibration unit supplies the bias circuit with a first calibration control signal (306, CAL_I_{PU}) responsive to an amplitude error with respect to a predetermined first reference value in sampling amplitude information of an output of the sampling circuit during the first calibrating operation.

The plurality of pattern-generating cells of the generator produce a repeat pulse (PLSP) at the output terminal (303) according to pull-up by the pull-up variable constant-current transistor and pull-down by the pull-down variable constant-current transistor during a second calibrating operation.

The sampling circuit of the calibration unit samples a DC level (Vsmp) of the output terminal (303) just after the repeat pulse (PLSP) is produced during the second calibrating operation.

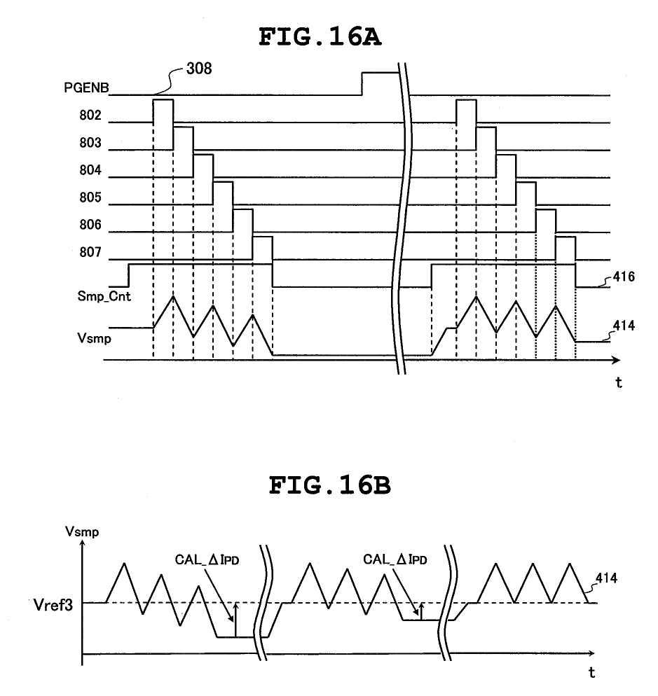

The control circuit of the calibration unit supplies the bias circuit with a second calibration control signal (306, CAL_ΔI_{PD}) responsive to a DC level error with respect to a predetermined second reference value in sampling DC level information, which is an output of the sampling circuit, during the second calibrating operation (see FIG. 16).

According to the above-described embodiment, the first calibrating operation makes it possible to calibrate the amplitude of the transmit pulse produced at the output terminal (303) into a predetermined first reference value during the transmitting operation. In addition, according to the embodiment, the second calibrating operation makes it possible to calibrate the DC level (Vsmp) of the output terminal (303) just after producing of the repeat pulse (PLSP) of the transmit pulse produced at the output terminal (303) into a predetermined second reference value during the transmitting operation.

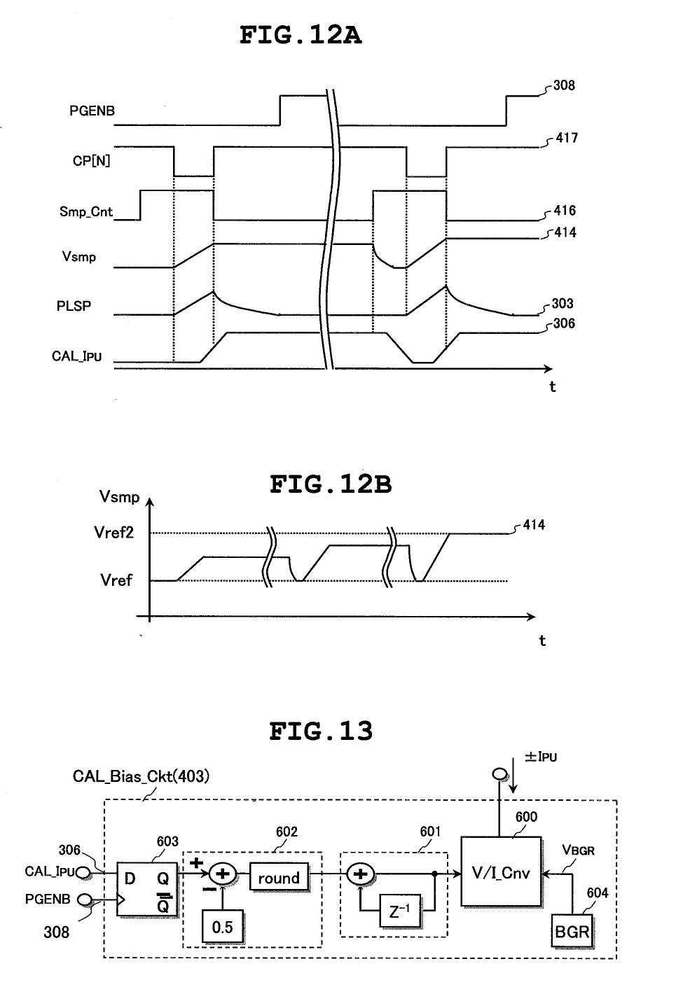

In the semiconductor integrated circuit according to a preferred embodiment, the bias circuit corrects a current value of at least one of the pull-up current and the pull-down current of the plurality of pattern-generating cells of the generator (111) in response to the first calibration control signal during the first calibrating operation (see FIGS. 11 and 12).

In the semiconductor integrated circuit according to another preferred embodiment, the bias circuit corrects imbalance of a current value of the other of the pull-up current and pull-down current of the plurality of pattern-generating cells of the generator with the current value of the one current in response to the second calibration control signal during the second calibrating operation (see FIGS. 15 and 16).

In the semiconductor integrated circuit according to a more preferred embodiment, the control circuit is a voltage comparator (412) which compares the sampling amplitude information of the sampling circuit with the predetermined first reference value, and compares the sampling DC level information of the sampling circuit with the predetermined second reference value (see FIG. 15).

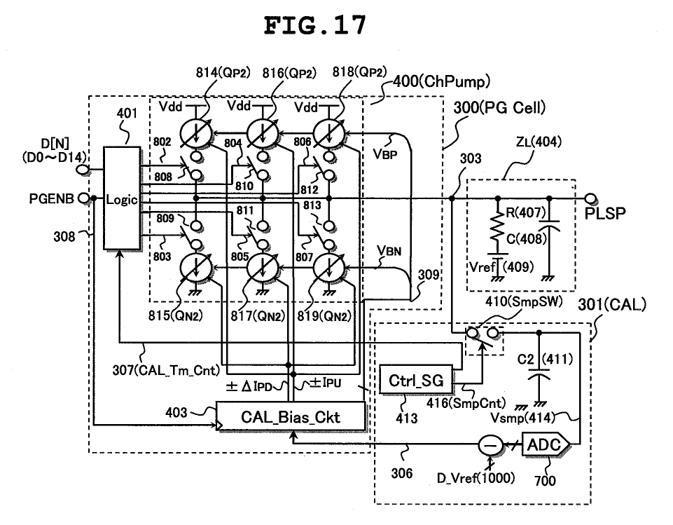

In the semiconductor integrated circuit according to another more preferred embodiment, the control circuit includes an analog-to-digital converter (700) for converting a voltage of the sampling amplitude information of the sampling circuit and a voltage of the sampling DC level information of the sampling circuit into respective digital signals (see FIG 17).

In the semiconductor integrated circuit according to a further more preferred embodiment, the second calibrating operation is executed after the first calibrating operation.

In the semiconductor integrated circuit according to another still more preferred embodiment, the generator alternately and repeatedly produces a positive pulse having a positive peak trending from a DC voltage to a source voltage, and a negative pulse having a negative peak trending from the DC voltage to a ground voltage, thereby producing the transmit pulse(OUT) (see FIG. 2).

In the semiconductor integrated circuit according to a specific embodiment, the generator includes a first generator (111) and a second generator (112). One of the first generator (111) and second generator (112) produces a first pulse (PLSP) consisting of positive pulses having positive peaks trending from the DC voltage to the source voltage at times ranked at even ordinal numbers in the plurality of times of the transmit pulse (OUT) in response to a level of a transmit baseband signal (BB). The other one of the first generator (111) and second generator (112) produces a second pulse (PLSN) consisting of positive pulses having positive peaks trending from the DC voltage to the source voltage at times ranked at odd ordinal numbers in the plurality of times of the transmit pulse (OUT) in response to the level of the transmit baseband signal (BB). The transmit pulse (OUT) is produced by subtraction of one of the first pulse (PLSP) and second pulse (PLSN) from the other (see FIG. 2).

In the semiconductor integrated circuit according to another specific embodiment, the generator includes a first generator (111) and a second generator (112). One of the first generator (111) and second generator (112) produces a first pulse (PLSP) consisting of negative pulses having negative peaks trending from the DC voltage to the ground voltage at times ranked at even ordinal numbers in the plurality of times of the transmit pulse (OUT) in response to a level of a transmit baseband signal (BB). The other one of the first generator (111) and second generator (112) produces a second pulse (PLSN) consisting of negative pulses having negative peaks trending from the ground voltage to the source voltage at times ranked at odd ordinal numbers in the plurality of times of the transmit pulse (OUT) in response to the level of the transmit baseband signal (BB). The transmit pulse (OUT) is produced by subtraction of one of the first pulse (PLSP) and second pulse (PLSN) from the other.

In the semiconductor integrated circuit according to the most specific embodiment, the pull-up variable constant-current transistor (Q_{P2}) and the pull-down variable constant-current transistor (Q_{N2}) of each of the plurality of pattern-generating cells (300, PG Cell1-PG Cell7) are a PMOS and an NMOS, respectively (see FIG. 6).

[2] A method for operating an ultra wide band-impulse radio-transmitter implemented on a semiconductor integrated circuit according to a preferred embodiment in another aspect of the invention includes a preparing step of preparing the ultra wide band-impulse radio-transmitter which produces a transmit pulse having an impulse waveform with predetermined amplitude values at a plurality of times at an output terminal during a transmitting operation.

The operating method includes a first step of executing a first calibrating operation and a second step of executing a second calibrating operation, as parts of the transmitting operation.

The operating method includes, as a part of the transmitting operation, a third step of transmitting the transmit pulse having the impulse waveform with the predetermined amplitude values at the plurality of times after the first and second steps.

The semiconductor integrated circuit has: a generator (111) including a plurality of pattern-generating cells (300, PG Cell1-PG Cell7) for producing the transmit pulse (OUT); and a calibration unit (301, CAL) for calibrating the transmit pulse (OUT) in amplitude and DC level fluctuation (see FIGS. 7 and 10).

The plurality of pattern-generating cells each include a pull-up variable constant-current transistor (Q_{P2}) for passing a pull-up current through the output terminal (303), and a pull-down variable constant-current transistor (Q_{N2}) for passing a pull-down current through the output terminal (303) (see FIG. 6).

The generator (111) includes a bias circuit (403, CAL_Bias_Ckt) for supplying the pull-up variable constant-current transistor and pull-down variable constant-current transistor of each pattern-generating cell with a pull-up bias voltage (VBP) and a pull-down bias voltage (VBN) respectively (see FIG. 6).

The calibration unit (301, CAL) includes a sampling circuit (410, 411) for sampling a voltage at the output terminal (303), and a control circuit (412, 700) for controlling the pull-up and pull-down bias voltages from the bias circuit in response to an output from the sampling circuit (see FIGS. 11 and 15).

At least one of the plurality of pattern-generating cells of the generator produces a pulse amplitude (PLSP) at the output terminal (303) during the first calibrating operation.

The sampling circuit of the calibration unit samples the pulse amplitude at output terminal during the first calibrating operation.

The control circuit of the calibration unit supplies the bias circuit with a first calibration control signal (306, CAL_I_{PU}) responsive to an amplitude error with respect to a predetermined first reference value in sampling amplitude information of an output of the sampling circuit during the first calibrating operation.

The plurality of pattern-generating cells of the generator produce a repeat pulse (PLSP) at the output terminal (303) according to pull-up by the pull-up variable constant-current transistor and pull-down by the pull-down variable constant-current transistor during a second calibrating operation.

The sampling circuit of the calibration unit samples a DC level (Vsmp) of the output terminal (303) just after the repeat pulse (PLSP) is produced during the second calibrating operation.

The control circuit of the calibration unit supplies the bias circuit with a second calibration control signal (306, CAL_ΔI_{PD}) responsive to a DC level error with respect to a predetermined second reference value in sampling DC level information of the output of the sampling circuit, during the second calibrating operation (see FIGS. 16A and 16B).

### 2. Further Detailed Description of the Preferred Embodiments

These embodiments of the invention will be described here further in detail. The detailed descriptions of best modes for embodying the invention are presented below with reference to the drawings. Now, it is noted that in all the drawings to which reference is made in describing the best modes for embodying the invention, members having identical functions are identified by the same numeral, character or sign, and the iteration of the description thereof is avoided.

### <<Basic Configuration of the Ultra Wide Band-Impulse Radio-Transmitter>>

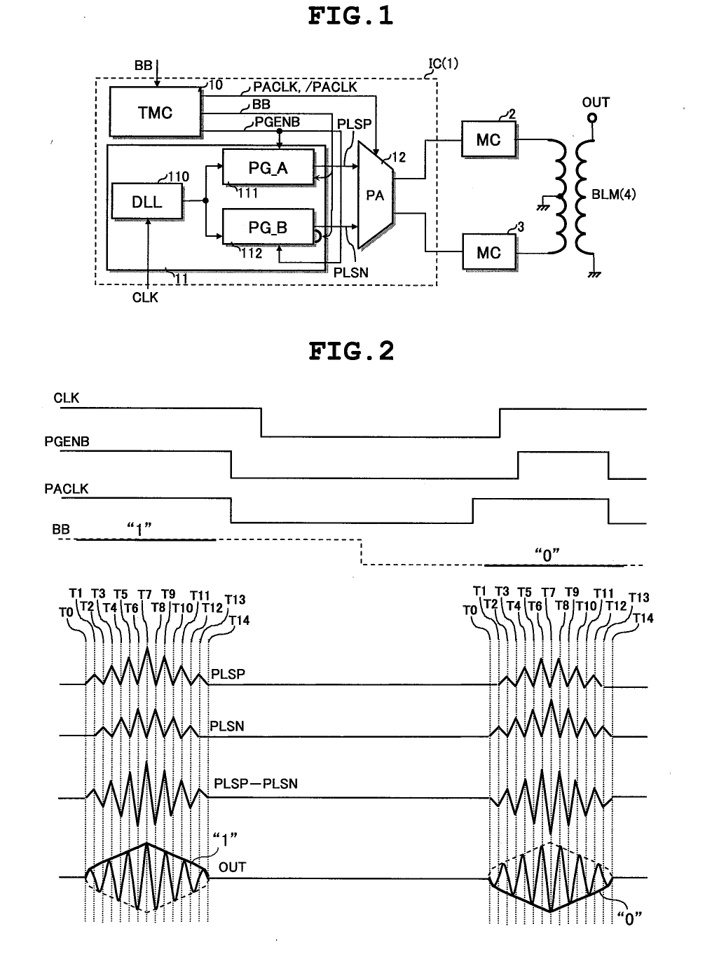

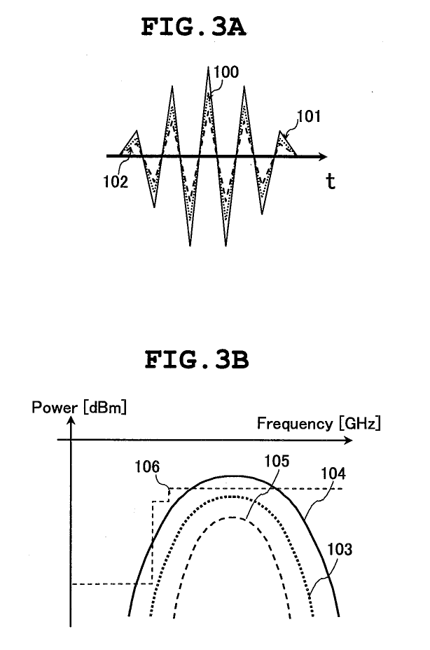

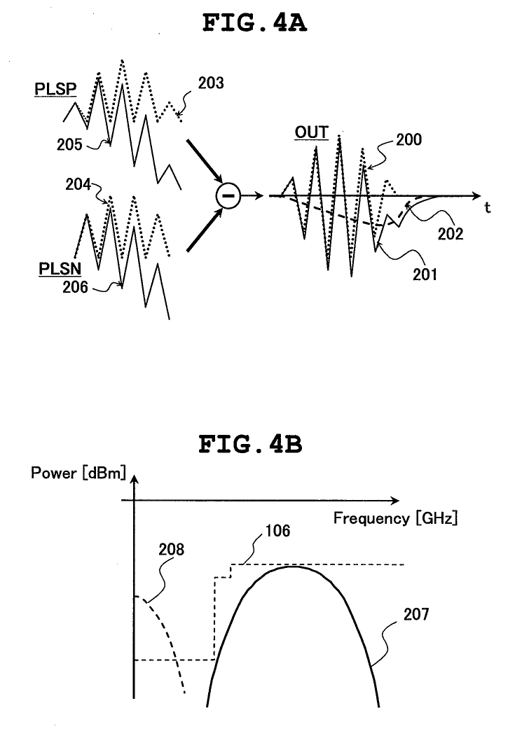

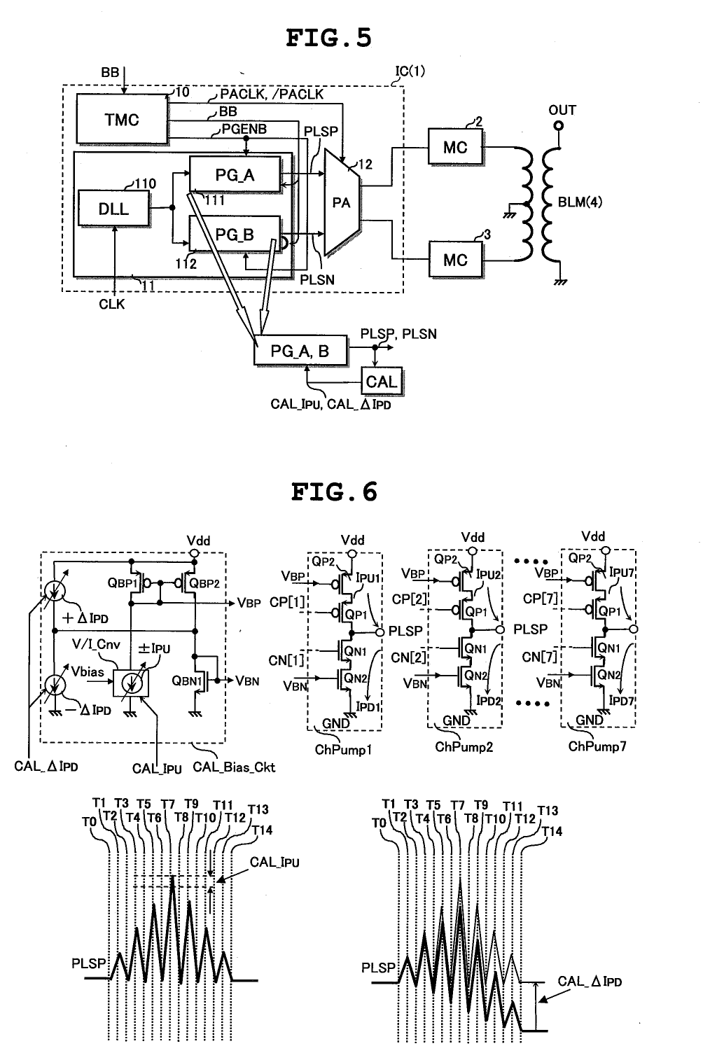

FIG. 5 is a diagram showing an ultra wide band-impulse radio-transmitter according to an embodiment of the invention. The transmitter shown in FIG. 5 is identical in its basic configuration with the transmitter shown in FIG. 1, which has been studied by the inventors prior to the invention. Namely, the transmitter in FIG. 5 includes a semiconductor integrated circuit 1, a pair of output matching circuits 2 and 3, and a balun 4. The semiconductor integrated circuit 1 includes a timing controller 10, a pulse generator 11, and a power amplifier 12. The pulse generator 11 includes a delayed locked loop (DLL) 110 and a pair of pattern generators 111 and 112.

The timing controller 10 of the semiconductor integrated circuit 1 is supplied with a transmit digital baseband signal BB from a baseband LSI (not shown). The timing controller 10 produces control signals PACLK and /PACLK for the power amplifier 12, and a control signal PGENB for the pair of pattern generators 111 and 112 of the pulse generator 11. The delay locked loop (DLL) 110 of the pulse generator 11 is supplied with a clock signal CLK. The delay locked loop 110 produces delay signals different in timing, which are supplied to the pair of pattern generators 111 and 112. The pattern generators 111 and 112 each include a plurality of pattern-generating cells (PG cell). When supplied with delay signals, the pattern-generating cells produce triangular wave pulses. The amplitude of the triangular wave pulse produced by each pattern-generating cell is proportional to the gate size of PMOS and NMOS of the charge pump. The output signals PLSP and PLSN from the paired pattern generators 111 and 112 are amplified by the power amplifier 12. The output signals of the power amplifier 12 are passed through the output matching circuits 2 and 3 and then supplied to the balun 4 in an output portion of the transmitter. In the balun 4, the output signals of the power amplifier 12 undergo subtraction, and thus a final transmit pulse OUT is formed.

The semiconductor integrated circuit 1 of the transmitter in FIG. 5 differs from the semiconductor integrated circuit 1 of the transmitter of FIG. 1 in that the paired pattern generators 111 and 112 of the pulse generator 11 each include a calibration unit CAL as shown in a lower portion of FIG. 5. The calibration unit CAL executes a transmit-calibrating operation prior to a normal transmitting operation of the transmitter in FIG. 5 according to a typical UWB-IR system. In other words, the calibration units CAL of the paired pattern generators 111 and 112 of the pulse generator 11 calibrate, in amplitude value and DC level fluctuation, repeat pulse signals PLSP and PLSN formed by outputs of the pattern generators. Thus, the electrical property of the final transmit pulse OUT meets the FCC spectral mask regulations After the transmit-calibrating operation, the transmitter in FIG. 5 starts the normal transmitting operation according to a typical UWB-IR system.

### <<Calibrating Operation by the Calibration Unit>>

FIG. 6 is a diagram for explaining the calibrating operation by the calibration unit CAL shown in FIG. 5, which shows an internal circuit configuration of the pair of pattern generators 111 and 112, and the waveform of the repeat pulse signal PLSP/PLSN.

### <<Operation of Calibrating the Peak Amplitude of Triangular Wave Pulses of Repeat Pulse Signals>>

An upper right portion of FIG. 6 shows charge pumps ChPump1-ChPump7 in output portions of the pattern-generating cells which produce triangular wave pulses, and are included in the paired pattern generators 111 and 112 shown in FIG. 5. The peak amplitudes of triangular wave pulses of the repeat pulse signals PLSP and PLSN produced from output of the pattern generators 111 and 112 at thirteen times T1 to T13 are determined by the thirteen pattern-generating cells. The triangular wave pulse peak amplitudes of the repeat pulse signals PLSP and PLSN at the thirteen times depend on the gate sizes of the constant-current PMOSs Q_{P2} and the gate sizes of the constant-current NMOSs Q_{N2} of the charge pumps in output portions of the thirteen pattern-generating cells. In each of the charge pumps ChPump1-ChPump7, a switch PMOS Q_{P1} is connected between the constant-current PMOS Q_{P2} and the output terminal, and a switch NMOS Q_{N1} is connected between the output terminal and the constant-current NMOS Q_{N2}. To gate input terminals of the switch PMOS Q_{P1} and switch NMOS Q_{N1}, charge-pump-control input signals CP and CN are supplied respectively. The charge-pump-control input signals CP and CN are produced in response to the level of the transmit digital baseband signal BB in synchronization with the thirteen times T1 to T13 responsive to delay signals of the DLL 110. The charge-pump-control input signals CP and CN are used to control whether or not to generate a triangular wave pulse at the thirteen times T1 to T13. However, the triangular wave pulse peak amplitudes at the times depend on the gate sizes of the constant-current PMOS Q_{P2} and constant-current NMOS Q_{N2}.

An upper left portion of FIG. 6 shows a calibration-bias circuit CAL_Bias_Ckt for supplying bias voltages V_{BP} and V_{BN} to the constant-current PMOS Q_{P2} and constant-current NMOS Q_{N2} of each of the charge pumps ChPump1-ChPump7. The bias circuit CAL_Bias_Ckt includes a voltage-current converter V/I_Cnv for converting a DC bias voltage Vbias into a DC bias current ±I_{PU}, a current mirror of PMOSs Q_{BP1} and Q_{BP2} and a bias NMOS Q_{BN1}. The DC bias current ±I_{PU} from the voltage-current converter V/I_Cnv is supplied to the diode-connected input PMOS Q_{BP1} of the PMOS current mirror of PMOSs Q_{BP1} and Q_{BP2}. Thus, a bias voltage V_{BP} for the constant-current PMOSs of the charge pumps is developed across the diode-connected input PMOS Q_{BP1}. The current mirror output current from the output of PMOS Q_{BP2} of the PMOS current mirror of PMOSs Q_{BP1} and Q_{BP2} is supplied to the diode-connected bias NMOS Q_{BN1}. Thus, a bias voltage V_{BN} for the constant-current NMOSs of the charge pumps is developed across the diode-connected bias NMOS Q_{BN1}.

In an lower left portion of FIG. 6 is presented a diagram showing peak amplitudes of triangular wave pulses of the repeat pulse signal PLSP produced as an output of the pattern generator 111, in which the triangular wave pulse peaks arise at the seven peak times. As for the triangular wave pulse peaks at the first to fourth times of the seven peak times, the peak amplitude increases with the elapse of time. In contrast, with the triangular wave pulse peaks at the fourth to seventh peak times, the triangular wave pulse peak amplitude decreases. The precedent half growing waveforms of the triangular wave pulses depend on the voltages resulting from time integration of the output capacities according to pull-up currents I_{PU1} to I_{PU7} of the constant-current PMOSs of the charge pumps. The subsequent half descending waveforms depend on the voltages resulting from time integration of the output capacities according to pull-down currents I_{PD1} to I_{PD7} of the constant-current NMOSs of the charge pumps. The variation of the peak amplitudes of triangular wave pulses at the seven peak times, which are contained in the repeat pulse signal PLSP produced as an output of the pattern generator 111 as shown in the lower left portion of FIGS. 6, are influenced primarily by the variation of the pull-up currents I_{PU1} to I_{PU7} of the constant-current PMOSs of the charge pumps.

The calibration unit CAL shown in FIG. 5 detects the variation of the peak amplitudes of the triangular wave pulses, and supplies a first calibration control signal CAL_I_{PU} responsive to the result of the detection to the voltage-current converter V/I_Cnv of the calibration-bias circuit CAL_Bias_Ckt. Then, the voltage-current converter V/I_Cnv changes the rate of conversion of DC bias voltage Vbias to DC bias current ±I_{PU} in response to the first calibration control signal CAL_I_{PU}. Thus, the bias voltage V_{BP} for the constant-current PMOSs of the charge pumps ChPump1-ChPump7 is calibrated, and therefore the values of the pull-up currents I_{PU1} to I_{PU7} of the constant-current PMOSs are calibrated. In this way, the calibration unit CAL automatically calibrates the variation of the triangular wave pulse peak amplitudes at the seven beak times, which are contained in the repeat pulse signal PLSP produced by the pattern generator 111.

The first calibration control signal CAL_I_{PU} from the calibration unit CAL is e.g. a digital signal of two bits or larger, and is stored in a register of two bits or larger size inside the calibration-bias circuit CAL_Bias_Ckt. The rate of conversion of DC bias voltage Vbias to DC bias current ±I_{PU} in the voltage-current converter V/I_Cnv is set according to the first calibration control signal CAL_I_{PU} thus stored in the register.

Now, it is noted that in calibrating the bias voltage V_{BP} for the constant-current PMOSs of the charge pumps, the bias voltage V_{BN} for the constant-current NMOSs of the charge pumps is also changed. As long as the balance between the pull-up current I_{PU} of PMOS and the pull-down current I_{PD} of NMOS is kept well in the charge pump of each of the pattern-generating cells (PG cell), the DC level fluctuation of the repeat pulse signal PLSP never occurs even when the variation of the peak amplitudes of triangular wave pulses of the repeat pulse signal PLSP is calibrated.

### <<Operation of Calibrating DC Level of the Repeat Pulse Signal>>

However, when the balance between the pull-up current I_{PU} of PMOS and the pull-down current I_{PD} of NMOS in the charge pump of each of the pattern-generating cells (PG cell) is disturbed, the DC level fluctuation of the repeat pulse signal PLSP will be caused as shown in a lower right portion of FIG. 6. When the pull-down current I_{PD} of NMOS of the charge pump is larger than the pull-up current I_{PU} of PMOS, the DC level of the repeat pulse signal PLSP lowers. In contrast, when the pull-down current I_{PD} of NMOS is smaller than the pull-up current I_{PU} of PMOS, the DC level rises. The calibration unit CAL shown in FIG. 5 detects the DC level fluctuation of the repeat pulse signal PLSP, and supplies the second calibration control signal CAL_ΔI_{PD}, which depends on the result of the detection, to a pull-down current-increasing variable current source +ΔI_{PD} and a pull-down current-decreasing variable current source −ΔI_{PD}. The pull-down current-increasing variable current source +ΔI_{PD} is connected in series with the diode-connected bias NMOS Q_{BN1} between a source voltage Vdd and the ground voltage. The pull-down current-decreasing variable current source −ΔI_{PD} is connected in parallel with the diode-connected bias NMOS Q_{BN1}.

When the DC level of the repeat pulse signal PLSP lowers, the calibration unit CAL shown in FIG. 5 decreases the current of the pull-down current-increasing variable current source +ΔI_{PD} and increases the current of the pull-down current-decreasing variable current source −ΔI_{PD} by means of the second calibration control signal CAL_ΔI_{PD}. Then, the bias voltage V_{BN} developed across the diode-connected bias NMOS Q_{BN1} is decreased, and thus the pull-down currents I_{PD1} to I_{PD7} of the constant-current NMOSs of the charge pumps are reduced. In this way, the calibration unit CAL calibrates the repeat pulse signal PLSP produced by the pattern generator 111 so that the DC level of the signal PLSP is raised automatically on the reduction of it. In contrast, when the DC level of the repeat pulse signal PLSP rises, the calibration unit CAL shown in FIG. 5 increases the current of the pull-down current-increasing variable current source +ΔI_{PD} and decreases the current of the pull-down current-decreasing variable current source −ΔI_{PD} by means of the second calibration control signal CAL_ΔI_{PD}. Then, the bias voltage V_{BN} developed across the diode-connected bias NMOS Q_{BN1} is increased, and thus the pull-down currents I_{PD1} to I_{PD7} of the constant-current NMOSs of the charge pumps are increased. In this way, the calibration unit CAL calibrates the repeat pulse signal PLSP produced by the pattern generator 111 so that the DC level of the signal PLSP is lowered automatically on the rise of it.

The second calibration control signal CAL_ΔI_{PD} from the calibration unit CAL is e.g. a digital signal of two bits or larger, and is stored in a register of two bits or larger size inside the calibration-bias circuit CAL_Bias_Ckt. The currents of the pull-down current-increasing variable current source +ΔI_{PD} and the pull-down current-decreasing variable current source −ΔI_{PD} are set according to the second calibration control signal CAL_ΔI_{PD} thus stored in the register.

Incidentally, as in the case of the transmitter as shown in FIG. 1, in the UWB-IR transmitter according to the embodiment of the invention shown in FIG. 5, the output signals PLSP and PLSN of the pair of pattern generators 111 and 112 of the pulse generator 11 are passed through the power amplifier 12 and the output matching circuits 2 and 3, and subjected to subtraction in the balun 4. Thus, the final transmit pulse OUT as shown in FIG. 2 is formed by the balun 4.

Also, in the UWB-IR transmitter according to the embodiment of the invention shown in FIG. 5, when the transmit digital baseband signal BB from the baseband LSI is at High level “1” as shown in FIG. 2, a final transmit pulse OUT corresponding to High level “1” is formed. The transmit pulse OUT corresponding to High level “1” has fifteen peaks at T0 to T14. Of the peaks, the seven peaks at T1, T3, T5, T7, T9, T11, T13 ranked at even ordinal numbers are positive ones, and the six peaks at T2, T4, T6, T8, T10, T12 ranked at odd ordinal numbers are negative ones. Further, in the UWB-IR transmitter according to the embodiment of the invention shown in FIG. 5, when the transmit digital baseband signal BB from the baseband LSI is at Low level “0” as shown in FIG. 2, a final transmit pulse OUT corresponding to Low level “0” is formed. The transmit pulse OUT corresponding to Low level “0” has fifteen peaks at T0 to T14. Of the peaks, the seven peaks at T1, T3, T5, T7, T9, T11, T13 ranked at even ordinal numbers are negative ones, and the six peaks at T2, T4, T6, T8, T10, T12 ranked at odd ordinal numbers are positive ones.

The final transmit pulses OUT, which correspond to High level “1” and Low level “0” as shown in FIG. 2, are transmit-impulse signals each having an envelope curve called “raised-cosine” in the field of the UWB-IR communications system.

### <<Configurations of Delayed Locked Loop and Pattern Generators>>

FIG. 7 is a diagram showing configurations of the delay locked loop (DLL) 110 and paired pattern generators (PG_A, PG_B) 111 and 112 in the pulse generator 11 of the semiconductor integrated circuit 1 of the UWB-IR transmitter shown in FIG. 5.

As shown in FIG. 7, the delay locked loop (DLL) 110 includes a delay chain including sixteen delay circuits D connected in series, a phase comparator PD, and a charge pump circuit (CP) for delay control, in which, a clock signal CLK is supplied to one input terminal of the phase comparator PD and an input terminal of the first-stage delay circuit D of the delay chain, and a delay signal output by the final-stage delay circuit D of the delay chain is supplied to the other input terminal of the phase comparator PD.

Therefore, in the delay locked loop (DLL) 110, the sixteen delay circuits D of the delay chain are controlled in delay time by negative feedback so that the phase of the clock signal CLK at the input terminal of the first-stage delay circuit D of the delay chain is coincident with that of the delay signal output by the final-stage delay circuit D of the delay chain. Specifically, the time difference between the time of input of the clock signal CLK to the input terminal of the first-stage delay circuit D of the delay chain and the time of output of the delay signal output by the final-stage delay circuit D represents the sum of delay times created by the sixteen delay circuits D of the delay chain. It is noted that the delay times of the sixteen delay circuits D of the delay chain are controlled by negative feedback to be substantially identical to one another.

Fifteen delay signals D0-D14 arising between coupled delay circuits of the delay chain of the delayed locked loop (DLL) 110 are supplied to the thirteen pattern-generating cells PG cell1-PG cell6, PG cell7, and PG cell6-PG cell1 of each of the paired pattern generators (PG_A, PG_B) 111 and 112. The thirteen pattern-generating cells are supplied with the pattern-generation control signal PGENB from the timing controller 10 and the transmit digital baseband signal BB.

The outputs of the charge pumps ChPump1-ChPump7 in output portions of the thirteen pattern-generating cells of the one pattern generator (PG_A) 111 are connected together with the output terminal through which the one repeat pulse signal PLSP produced is output. To the output terminal, one ends of an output-parasitic capacitance C and a resistor R are connected. The other end of the resistor R accepts supply of a reference voltage Vref. The outputs of the charge pumps ChPump1-ChPump7 in output portions of the thirteen pattern-generating cells of the other pattern generator (PG_B) 112 are also connected together with the output terminal through which the other repeat pulse signal PLSN produced is output. Also, to the output terminal, one ends of an output-parasitic capacitance C and a resistor R are connected, and the other end of the resistor R accepts supply of a reference voltage Vref.

### <<Configuration of Pattern-generating Cells of Pattern Generators>>

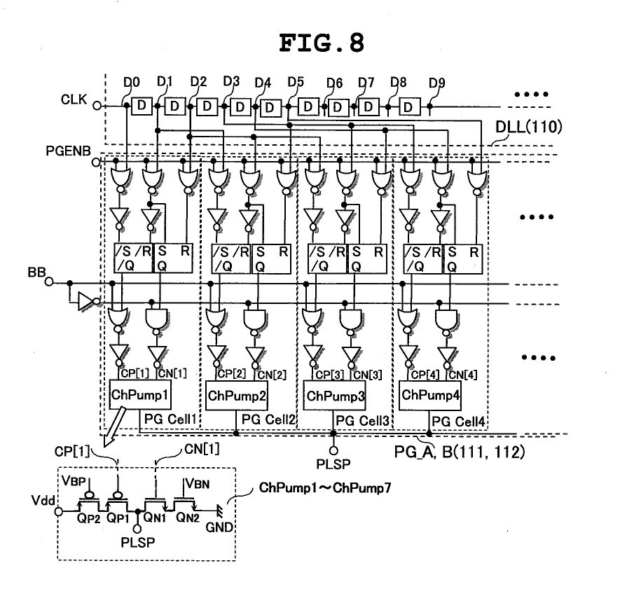

FIG. 8 is a diagram showing a configuration of the pattern-generating cells PG cell1-PG cell16, PG cell7, and PG cell16-PG cell1 of the paired pattern generators (PG_A, PG_B) 111 and 112 shown in FIG. 7. As shown in FIG. 8, the thirteen pattern-generating cells PG cell1-PG cell6, PG cell7, and PG cell6-PG cell1 each include three NOR input circuits. The pattern-generation control signal PGENB from the timing controller 10 is supplied to one input terminals of the three NOR input circuits. To the other input terminals of the three NOR input circuits, the delay signals from the delay chain in DLL (110) are supplied. Outputs from the first and second NOR input circuits are sent to an inversion-set input /S and an inversion-reset input /R of one flip-flop through respective inverters. Outputs from the second and third NOR input circuits are sent to a noninversion-set input S and a noninversion-reset input R of the other flip-flop.

Also, the thirteen pattern-generating cells PG cell1-PG cell6, PG cell7, and PG cell6-PG cell1 each include a NOR output circuit and a NAND output circuit. The NOR output circuit is supplied with the transmit digital baseband signal BB and an inverted output /Q of the one flip-flop. The NAND output circuit is supplied with an inverted signal of the transmit digital baseband signal BB and a noninverted output Q from the other flip-flop. In addition, inverters, one of which accepts an output of the NOR output circuit and the other accepts an output of the NAND output circuit, produce the charge-pump-control input signals CP and CN respectively. The charge-pump-control input signals CP and CN are supplied to gate input terminals of the switch PMOS Q_{P1} and switch NMOS Q_{N1} of the charge pump in the output portion of each pattern-generating cell.

The weights of the current values of the pull-up current I_{PU} of PMOS and pull-down current I_{PD} of NMOS of the charge pump ChPump1 in the output portion of each of the first and thirteenth pattern-generating cells PG cell1 in the pair of pattern generators 111 and 112 are set to one. In addition, the weights of the current values of the pull-up current I_{PU} of PMOS and the pull-down current I_{PD} of NMOS of the charge pump ChPump2 in the output portion of each of the second and twelfth pattern-generating cells PG cell2 are set to two. Further, the weights of the current values of the pull-up current I_{PU} of PMOS and the pull-down current I_{PD} of NMOS of the charge pump ChPump3 in the output portion of each of the third and eleventh pattern-generating cells PG cell3 are set to three. Still further, the weights of the current values of the pull-up current I_{PU} of PMOS and the pull-down current I_{PD} of NMOS of the charge pump ChPump4 in the output portion of each of the fourth and tenth pattern-generating cells PG cell4 are set to four. Furthermore, the weights of the current values of the pull-up current I_{PU} of PMOS and the pull-down current I_{PD} of NMOS of the charge pump ChPump5 in the output portion of each of the fifth and ninth pattern-generating cells PG cell5 are set to five. Moreover, the weights of the current values of the pull-up current I_{PU} of PMOS and the pull-down current I_{PD} of NMOS of the charge pump ChPump6 in the output portion of each of the sixth and eighth pattern-generating cells PG cell6 are set to six. Besides, the weights of the current values of the pull-up current I_{PU} of PMOS and the pull-down current I_{PD} of NMOS of the charge pump ChPump7 in the output portion of the seventh pattern-generating cell PG cell7 at the center of the pattern-generating cells is set to seven.

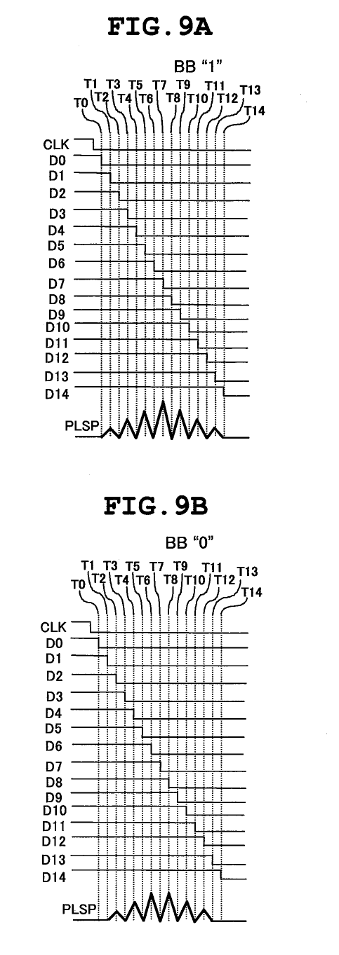

FIGS. 9A and 9B are diagrams each showing a waveform of the pulse signal PLSP formed by the one pattern generator (PG_A) 111 of the pulse generator 11 in response to the level of the transmit digital baseband signal BB.

Specifically, as shown in FIGS. 9A and 9B, the one pattern generator (PG_A) 111 produces a repeat pulse signal PLSP having seven positive peaks at times T1, T3, T5, T7, T9, T11 and T13 ranked at even ordinal numbers in the fifteen times T0 to T14 in response to High level “1” of the transmit digital baseband signal BB. In addition, the pattern generator (PG_A) 111 produces a repeat pulse signal PLSP having six positive peaks at times T2, T4, T6, T8, T10 and T12 ranked at odd ordinal numbers in the fifteen times T0 to T14 in response to Low level “0” of the transmit digital baseband signal BB.

### <<Configuration of Calibration Unit>>

FIG. 10 is a diagram showing the configuration of the calibration unit CAL shown in FIG. 5 further in detail. As shown in FIG. 10, the calibration unit (CAL) 301 is connected with a pattern-generating cell (PG cell) 300, which represents the pattern-generating cells included in the pair of pattern generators 111 and 112 shown in FIG. 5.

During a period for calibrating the amplitude values of the repeat pulse signals PLSP (303) and PLSN (304) produced by the pattern-generating cell (PG Cell) 300, the calibration unit (CAL) 301 keeps supplying a calibration timing signal 307 (CAL_Tm_Cnt) of High level “1”. The repeat pulse signals PLSP(303) and PLSN(304) produced by the pattern-generating cell (PG Cell) 300 are supplied to the calibration unit (CAL) 301. Thus, the calibration unit (CAL) 301 performs detection and calibration of the amplitude values and DC levels of the repeat pulse signals PLSP (303) and PLSN (304). The calibration unit (CAL) 301 produces a first calibration control signal CAL_I_{PU} (306) based on a result of the comparison of detected amplitude values of the repeat pulse signals with their design target values, and then supplies the first signal to the pattern-generating cell (PG Cell) 300. During the calibrating operation, the timing controller (TMC) 10 keeps supplying the pattern-generation control signal PGENB of Low level “0” to the pattern-generating cell (PG Cell) 300.

### <<Configuration of Calibration Unit for Amplitude Value Control>>

FIG. 11 is a diagram showing an example of configuration of the pattern-generating cell (PG Cell) 300 and the calibration unit (CAL) 301 for amplitude value control shown in FIG. 10 further in detail.

The charge pump 400 of the pattern-generating cell (PG Cell) 300 shown in FIG. 11 represents the charge pumps ChPump1-ChPump7 in the pattern-generating cells shown in FIG. 8. The variable constant-current source 405 and switch 406 (SW1) of the charge pump 400 of FIG. 11 represent the constant-current PMOSs Q_{P2} and switch PMOSs Q_{P1} of the charge pumps ChPump1-ChPump7 of FIG. 8. In addition, the calibration-bias circuit 403 (CAL_Bias_Ckt) of the charge pump 400 of FIG. 11 corresponds to the bias circuit shown in the upper left portion of FIG. 6. Therefore, the calibration-bias circuit 403 (CAL_Bias_Ckt) of the charge pump 400 of FIG. 11 supplies the bias voltage 309 (V_{BP}) and DC bias current ±I_{PU} to the variable constant-current source 405.

In addition, the control logic 401 of the pattern-generating cell (PG Cell) 300 shown in FIG. 11 represents the NOR and NAND circuits, inverters, and flip-flops in the pattern-generating cells shown in FIG. 8. Therefore, the control signal 417 (CP [N]) supplied from the control logic 401 to the switch 406 (SW1) represents the charge-pump-control input signals CP[1]-CP[7] shown in FIGS. 6 and 8.

Further, to the output terminal 303 of the pattern-generating cell (PG Cell) 300 shown in FIG. 11, a load circuit 404 (Z_{L}) is connected. The load circuit represents combinations of the output-parasitic capacitance C, the resistor R and the source of the reference voltage Vref, which are connected to the output terminals of the repeat pulses PLSP and PLSN shown in FIG. 7. Also, the load circuit 404 (Z_{L}) includes an output-parasitic capacitance C (408), a resistor R (407) and a source of reference voltage Vref (409).

The calibration unit (CAL) 301 shown in FIG. 11 includes a sampling switch 410 (SmpSW), a sampling capacitance 411 (C2), a voltage comparator 412 (Comp), and a calibration control signal generator 413 (Ctrl_SG). The sampling switch 410 (SmpSW) has one signal terminal connected to the output terminal 303 of the pattern-generating cell (PG Cell) 300. The other signal terminal of the sampling switch 410 (SmpSW) is connected to the sampling capacitance 411 (C2) and an inversion input terminal of the voltage comparator 412 (Comp). In a calibrating operation mode, a calibration command is supplied to the calibration control signal generator 413 (Ctrl_SG). In response to the calibration command, the calibration control signal generator 413 (Ctrl_SG) supplies the calibration timing signal 307 (CAL_Tm_Cnt) to the control logic 401 of the pattern-generating cell (PG Cell) 300. Also, the calibration control signal generator 413 (Ctrl_SG) supplies a sampling control signal 416 (SmpCnt) to a control input terminal of the sampling switch 410 (SmpSW).

### <<Calibrating Operation for Amplitude Value Control>>

FIGS. 12A and 12B are waveform diagrams for explaining the calibrating operation for amplitude value control using the pattern-generating cell (PG Cell) 300 and calibration unit (CAL) 301 shown in FIG. 11. As shown in FIG. 12A, during a period that the pattern-generation control signal 308 (PGENB) from the timing controller (TMC) 10 is at Low level “0”, the calibrating operation for amplitude value control is executed. When the control signal 417 (CP [N]) supplied from the control logic 401 is turned to Low level “0”, the switch 406 (SW1) is controlled to ON state. Then, the pull-up current I_{PU} having flowed into the variable constant-current source 405 of the charge pump 400 is supplied to the load circuit 404 (Z_{L}) through the switch 406 (SW1) and the output terminal 303. At this time, the sampling control signal 416 (SmpSW) supplied to the control input terminal of the sampling switch 410 (SmpSW) has been also turned to High level “1”, and the sampling switch 410 (SmpSW) has been controlled to ON state. Therefore, the sampling capacitance 411 (C2) and the output-parasitic capacitance C (408) of the load circuit 404 (Z_{L}) are charged by the pull-up current I_{PU} of the variable constant-current source 405 of the charge pump 400.

As a result, the sampling voltage 414 (Vsmp) of the sampling capacitance 411 (C2) and the voltage of the repeat pulse signal PLSP at the output terminal 303 are raised during the period that the control signal 417 (CP [N]) is at Low level “0”. The voltage comparator 412 (Comp) compares the sampling voltage 414 (Vsmp) with the amplitude calibration reference voltage 415 (Vref2). When the amplitude of the repeat pulse signal PLSP at the output terminal 303 is small, the sampling voltage 414 (Vsmp) is made lower in level than the amplitude calibration reference voltage 415 (Vref2). Then, the first calibration control signal 306 (CAL_I_{PU}), which is an output from the voltage comparator 412 (Comp), is made High level. Therefore, the level of the DC bias current ±I_{PU}, which is supplied from the calibration-bias circuit 403 (CAL_Bias_Ckt) to the variable constant-current source 405 of the charge pump 400 is raised, and then the amplitude of the repeat pulse signal PLSP at the output terminal 303 is increased.

The calibrating operation for amplitude value control is continued until the amplitude of the repeat pulse signal PLSP at the output terminal 303 is raised and thus the sampling voltage 414 (Vsmp) coincides with the amplitude calibration reference voltage 415 (Vref2) as shown in FIG. 12B.

Now, it is recommended that during the calibrating operation for controlling the amplitude value of the repeat pulse signal PLSP at the output terminal 303, the sampling capacitance 411 (C2) and the output-parasitic capacitance C (408) of the load circuit 404 (Z_{L}) be charged by the pull-up currents I_{PU} of the thirteen constant-current PMOSs Q_{P2} of all the thirteen charge pumps of thirteen pattern-generating cells of each of the paired pattern generators (PG_A, PG_B) 111 and 112 of FIG. 7. However, these capacitances may be charged only by the pull-up current I_{PU} of the constant-current PMOS Q_{P2} of the charge pump ChPump7 of the center seventh pattern-generating cell PG Cell7 having the current value's weight set to seven.

### <<Calibration-Bias Circuit>>

FIG. 13 is a diagram showing a configuration of the calibration-bias circuit 403 (CAL_Bias_Ckt) of the charge pump 400 of the pattern-generating cell 300 of FIG. 11.

The calibration-bias circuit 403 (CAL_Bias_Ckt) of FIG. 13 includes a flip-flop 603, an encoder 602, an integrator 601, a voltage-current converter (V/I_Cnv) 600, and a band-gap reference circuit (BGR) 604.

To the data input terminal D of the flip-flop 603, the first calibration control signal 306 (CAL_I_{PU}) from the voltage comparator 412 (Comp) of the calibration unit (CAL) 301 is supplied. To the trigger input terminal of the flip-flop 603, the control signal PGENB from the timing controller 10 is supplied. The encoder 602 converts input signals “1” and “0” supplied from an output of the flip-flop 603 to output signals “1” and “−1”. The integrator 601 integrates an output from the encoder 602. The output signal of the integrator 601 resulting from the integration is applied to a variable resistor of the voltage-current converter V/I_Cnv 600 as a control signal.

Further, to the variable resistor of the voltage-current converter (V/I_Cnv) 600, a band-gap reference voltage VBGR is supplied from the band-gap reference circuit (BGR) 604. Therefore, the value of the DC bias current ±I_{PU} is set by the band-gap reference voltage V_{BGR} and the variable resistance of the voltage-current converter (V/I_Cnv) 600.

The variable DC bias current ±I_{PU} from the calibration-bias circuit 403 (CAL_Bias_Ckt) is supplied to the charge pump 400 of the pattern-generating cell (PG Cell) 300 of FIG. 11.

### <<Calibration Unit Incorporating Analog-to-Digital Converter>>

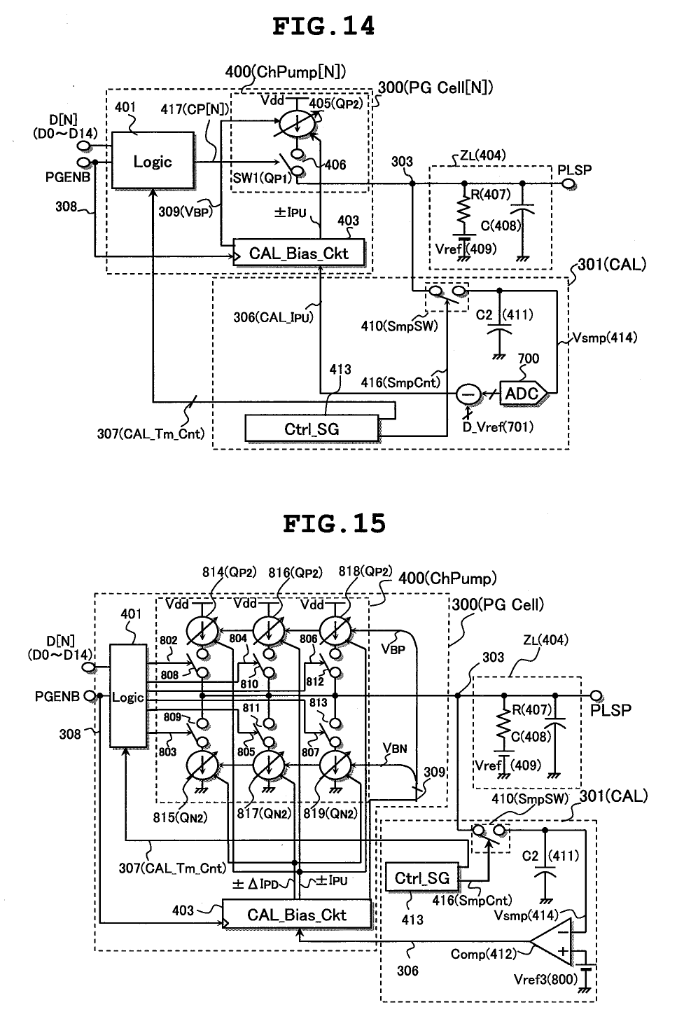

FIG. 14 is a diagram showing a modification of the example of configuration of the pattern-generating cell (PG Cell) 300 and the calibration unit (CAL) 301 for amplitude value control shown in FIG. 11, in which the voltage comparator 412 (Comp) and the amplitude calibration reference voltage 415 (Vref2) in the calibration unit (CAL) 301 of FIG. 11 are replaced with an analog-to-digital converter (ADC) 700 and reference voltage data (D_Vref) 701 respectively. The amplitude voltage of the repeat pulse signal PLSP at the output terminal 303 of the pattern-generating cell (PG Cell) 300 of FIG. 14 is converted by the analog-to-digital converter (ADC) 700 to an amplitude digital signal. The difference signal between the amplitude digital signal and the reference voltage data (D_Vref) 701 as an amplitude calibration reference digital signal is supplied to the calibration-bias circuit 403 (CAL_Bias_Ckt) as the first calibration control signal 306 (CAL_I_{PU}). The calibrating operation by the calibration unit (CAL) 301 of FIG. 14 is the same as that performed by the calibration unit (CAL) 301 of FIG. 11, and therefore the description thereof is omitted here.

### <<Configuration of Calibration Unit for DC Level Control>>

The calibration unit (CAL) 301 shown in FIG. 10 compares a design target value of DC level of the repeat pulse signal with a detected value, produces the second calibration control signal CAL_ΔI_{PD} (306), and supplies the signal to the pattern-generating cell (PG Cell) 300.

FIG. 15 is a diagram showing an example of configuration of the pattern-generating cell (PG Cell) 300 and the calibration unit (CAL) 301 for amplitude value control and DC level control shown in FIG. 10 further in detail.

The charge pump 400 of the pattern-generating cell (PG Cell) 300 shown in FIG. 15 represents the charge pumps ChPump1-ChPump7 inside the pattern-generating cells shown in FIG. 8. In the example shown by FIG. 15, three of thirteen pattern-generating cells PG Cell1-PG Cell6, PG Cell7, and PG Cell6-PG Cell1 are activated in the calibrating operation of the calibration unit (CAL) 301. However, the number of pattern-generating cells activated in the calibrating operation may be increased in order to facilitate error detection in spite of the increase in power consumption. The calibrating operation of the calibration unit (CAL) 301 of FIG. 15 is executed with variable constant-current sources 814, 816 and 818 and switches 808, 810 and 812 for pull-up and variable constant-current sources 815, 817 and 819, and switches 809, 811 and 813 for pull-down in the charge pump 400.

Before detection and calibration of DC levels of the repeat pulses PLSP and PLSN, the calibration unit (CAL) 301 of FIG. 15 for the paired pattern generators (PG_A, PG_B) 111 and 112 executes the operations of detecting and calibrating amplitude values of the repeat pulses PLSP and PLSN as described with reference to FIGS. 11 and 12. Specifically, in the example of FIG. 15, the pull-up currents of the variable constant-current sources 814, 816 and 818 for pull-up and the pull-down currents of the variable constant-current source 815, 817 and 819 for pull-down in the charge pump 400 are calibrated, whereby the amplitude values of the repeat pulses PLSP and PLSN are calibrated. After execution of the operations of detecting and calibrating the amplitude values of the repeat pulses PLSP and PLSN, the calibration unit (CAL) 301 starts the operations of detecting and calibrating the DC levels of the repeat pulses PLSP and PLSN.

FIGS. 16A and 16B are waveform diagrams for explaining an operation for DC level detection and calibration by the pattern-generating cell (PG Cell) 300 and the calibration unit (CAL) 301 shown in FIG. 15.

In response to the calibration timing signal 307 (CAL_Tm_Cnt) from the calibration control signal generator 413 (Cnt_SG), the control logic 401 forms a control signal for successively producing three triangular wave pulses. During the time that the triangular wave pulses are produced successively, the sampling switch 410 (SmpSW) is kept in ON state with the aid of the sampling control signal 416 (SmpSW) from the calibration control signal generator 413 (Ctrl_SG). The switches 808, 809, 810, 811, 812 and 813 are controlled to ON state according to control signals 802, 803, 804, 805, 806 and 807 in order. As a result, pull-up by the variable constant-current source 814, pull-down by the variable constant-current source 815, pull-up by the variable constant-current source 816, pull-down by the variable constant-current source 817, pull-up by the variable constant-current source 818, and pull-down by the variable constant-current source 819 are executed in order.

Imbalance between the pull-up current of PMOS and the pull-down current of NMOS of the charge pump of each of the pattern-generating cells causes the change in DC level of the repeat pulse PLSP just before and after successive producing of the triangular wave pulses. The DC level of the repeat pulse PLSP is shown by the sampling voltage 414 (Vsmp) of the sampling capacitance 411 (C2). In the example of FIGS. 16A and 16B, the sampling voltage 414 (Vsmp) just after successive producing of the triangular wave pulses is lower than the sampling voltage 414 (Vsmp) just before the successive producing.

The voltage comparator 412 (Comp) compares the sampling voltage 414 (Vsmp) with the DC level calibration reference voltage 800 (Vref3). When the pull-down current of NMOS of the charge pump is larger than the pull-up current of PMOS, the sampling voltage 414 (Vsmp) just after successive producing of the triangular wave pulses is lower than the DC level calibration reference voltage 800 (Vref3). Then, The second calibration control signal 306 (CAL_I_{PD}), which is an output from the voltage comparator 412 (Comp), is made High level. Thus, the level of the pull-down current-decreasing variable current source ±ΔI_{PD} supplied from the calibration-bias circuit 403 (CAL_Bias_Ckt) to the variable constant-current sources 815, 817 and 819 for pull-down of the charge pump 400 is increased, and the pull-down current of NMOS of the charge pump is decreased.

The calibrating operation for DC level control is continued until the sampling voltage 414 (Vsmp) just after successive producing of the triangular wave pulses at the output terminal 303 is increased and thus the sampling voltage 414 (Vsmp) coincides with the DC level calibration reference voltage 800 (Vref3) as shown in FIG. 16B.

When the pull-down current of NMOS of the charge pump is smaller than the pull-up current of PMOS, the sampling voltage 414 (Vsmp) just after successive producing of the triangular wave pulses is made higher in level than the DC level calibration reference voltage 800 (Vref3). Then, the second calibration control signal 306 (CAL_I_{PD}), which is an output from the voltage comparator 412 (Comp) is made lower in level. Thus, the level of the pull-down current-increasing variable current source ±ΔI_{PD} supplied from the calibration-bias circuit 403 (CAL_Bias_Ckt) to the variable constant-current sources 815, 817 and 819 for pull-down of the charge pump 400 is increased, and the pull-down current of NMOS of the charge pump is increased.

<<Calibration Unit with Analog-to-Digital Converter>>

FIG. 17 is a diagram showing a modification of the example of configuration of the pattern-generating cell (PG Cell) 300 and the calibration unit (CAL) 301 for amplitude value control and DC level control shown in FIG. 15, in which the voltage comparator 412 (Comp) and the DC level calibration reference voltage 800 (Vref3) in the calibration unit (CAL) 301 shown in FIG. 15 are replaced with an analog-to-digital converter (ADC) 700 and reference voltage data (D_Verf) 1000 respectively. The sampling voltage 414 (Vsmp) at the output terminal 303 of the pattern-generating cell (PG Cell) 300 of FIG. 17 just after successive producing of the triangular wave pulses is converted to an amplitude digital signal by the analog-to-digital converter (ADC) 700. The difference signal between the reference voltage data (D_Vref) 1000 as a DC level calibration reference digital signal and the sampling voltage 414 (Vsmp) just after successive producing of the triangular wave pulses is supplied to the calibration-bias circuit 403 (CAL_Bias_Ckt) as the second calibration control signal 306 (CAL_I_{PD}). The calibrating operation by the calibration unit (CAL) 301 of FIG. 17 is the same as executed by the calibration unit (CAL) 301 of FIG. 15, and therefore the description thereof is omitted here.

<<Calibration Unit with Counter>>

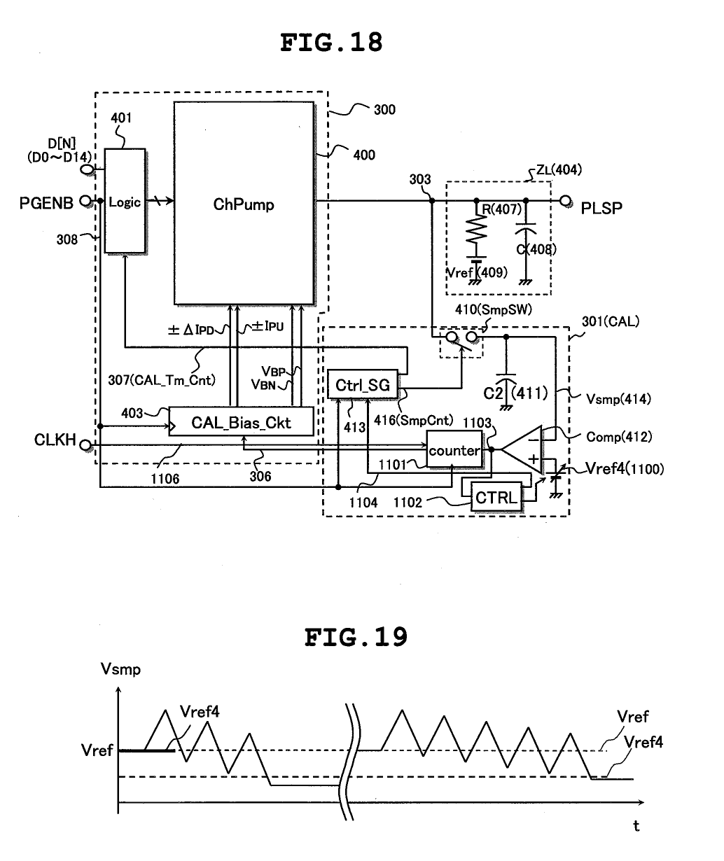

FIG. 18 is a diagram showing a modification of the example of configuration of the pattern-generating cell (PG Cell) 300 and the calibration unit (CAL) 301 for amplitude value control and DC level control shown in FIG. 15, in which a counter 1101 and a control circuit 1102 are added to the output of the voltage comparator 412 (Comp) in the calibration unit (CAL) 301 shown in FIG. 15.

First, it is required to judge whether the error in DC level of the sampling voltage 414 (Vsmp) of the sampling capacitance 411 (C2) is large or small by means of the variable constant-current sources for pull-up and pull-down in the charge pump 400. For this purpose, the DC level calibration reference voltage 1100 (Vref4) is set to be identical in level to the reference voltage 409 (Vref) supplied to the other end of the resistor R of the load circuit 404 (Z_{L}) prior to start of DC level calibration.

In this condition, the control logic 401 of FIG. 18 produces three triangular wave pulses successively as shown in FIG. 19 in the same way as adopted in the examples shown by FIGS. 15 and 16.

FIG. 19 is a waveform diagram for explaining an operation for DC level detection and calibration by the pattern-generating cell (PG Cell) 300 and the calibration unit (CAL) 301 shown in FIG. 18.

The DC level of the repeat pulse PLSP according to successive producing of three triangular wave pulses is judged by the voltage comparator 412 (Comp). When the result 1103 of the judgment by the voltage comparator 412 (Comp) implies a small error, the control circuit 1102 sets the DC level calibration reference voltage 1100 (Vref4) to be lower than the reference voltage 409 (Vref).

Next, in this condition, the control logic 401 of FIG. 18 successively produces triangular wave pulses as shown in FIG. 19, and the counter 1101 starts the operation of counting a DC level calibration clock CLKH. When the DC level of the sampling voltage 414 (Vsmp) of the sampling capacitance 411 (C2) is lowered to the DC level calibration reference voltage 1100 (Verf4) or below by successively producing triangular wave pulses, an output 1103 from the voltage comparator 412 (Comp) is changed from Low level to High level. As a result, the operation of counting the DC level calibration clock CLKH by the counter 1101 is stopped. The count value of the DC level calibration clock CLKH indicated by the counter 1101 is provided to the calibration-bias circuit 403 (CAL_Bias_Ckt). The calibration-bias circuit 403 (CAL_Bias_Ckt) increases the level of the pull-down current-decreasing variable current source ±ΔI_{PD} of the charge pump 400 and decreases the pull-down current of NMOS of the charge pump 400 according to the count value from the counter 1101. Setting is made so that the smaller the count value of the counter 1101 is, the larger a decrease of the pull-down current of NMOS of the charge pump 400 is. In this way, the operation of detecting and calibrating the DC level of the repeat pulse PLSP is implemented.

In contrast, when the result of the judgment by the voltage comparator 412 (Comp) implies a large error in DC level of the repeat pulse PLSP according to the successive producing of three triangular wave pulses, the control circuit 1102 sets the DC level calibration reference voltage 1100 (Verf4) to be higher than the reference voltage 409 (Vref).

Next, in this condition, the control logic 401 of FIG. 18 successively produces triangular wave pulses, and the counter 1101 starts the operation of counting the DC level calibration clock CLKH. When the DC level of the sampling voltage 414 (Vsmp) of the sampling capacitance 411 (C2) is raised to the DC level calibration reference voltage 1100 (Verf4) or above by successively producing triangular wave pulses, the output 1103 from the voltage comparator 412 (Comp) is changed from High level to Low level. As a result, the operation of counting the DC level calibration clock CLKH by the counter 1101 is stopped. The count value of the DC level calibration clock CLKH indicated by the counter 1101 is provided to the calibration-bias circuit 403 (CAL_Bias_Ckt) The calibration-bias circuit 403 (CAL_Bias_Ckt) increases the level of the pull-down current-increasing variable current source ±ΔI_{PD} of the charge pump 400 and increases the pull-down current of NMOS of the charge pump 400 in response to the count value of the counter 1101. Setting is made so that the smaller the count value of the counter 1101 is, the larger an increase of the pull-down current of NMOS of the charge pump 400 is. In this way, the operation of detecting and calibrating the DC level of the repeat pulse PLSP is implemented.

While the invention made by the inventor has been described specifically based on the embodiments above, the invention is not so limited. It is needless to say that various changes and modifications may be made without departing from the subject matter hereof.

For instance, in the embodiment of FIG. 2, the output signal PLSN of one pattern generator 112 is subtracted from the output signal PLSP of the other pattern generator 111 with the balun 4, whereby the final transmit pulse OUT is formed.

Now, according to another embodiment, in the condition where the logic level of the transmit digital baseband signal BB is reversed, a final transmit pulse OUT of the same waveform can be formed even when the output signal PLSP of the pattern generator 111 is subtracted from the output signal PLSN of the pattern generator 112 with the balun 4.

In the above embodiments, repeat pulses PLSP and PLSN consist of only positive pulses having positive peaks trending from a DC voltage to the source voltage, and the final transmit pulse OUT is formed by subtraction of one of repeat pulses PLSP and PLSN from the other. However, another embodiment may be arranged, in which the repeat pulses PLSP and PLSN consist of only negative pulses having negative peaks trending from a DC voltage to the ground voltage, and in which the final transmit pulse OUT may be formed by subtraction of one of repeat pulses PLSP and PLSN from the other. However, in this case, the amplitude of the final transmit pulse OUT is set mainly by the current value of the pull-down current of the charge pump of each pattern-generating cell.

What is claimed is:

1. A semiconductor integrated circuit incorporated in an ultra wide band-impulse radio-transmitter, which produces a transmit pulse having an impulse waveform with predetermined amplitude values at a plurality of times at an output terminal during a transmitting operation, comprising:
a generator including a plurality of pattern-generating cells for producing the transmit pulse; and
a calibration unit for calibrating the transmit pulse in amplitude and DC level fluctuation,
wherein the plurality of pattern-generating cells each include a pull-up variable constant-current transistor for passing a pull-up current through the output terminal, and a pull-down variable constant-current transistor for passing a pull-down current through the output terminal,
wherein the generator includes a bias circuit for supplying the pull-up variable constant-current transistor and pull-down variable constant-current transistor of each pattern-generating cell with a pull-up bias voltage and a pull-down bias voltage respectively,
wherein the calibration unit includes a sampling circuit for sampling a voltage at the output terminal, and a control circuit for controlling the pull-up and pull-down bias voltages from the bias circuit in response to an output from the sampling circuit,
wherein at least one of the plurality of pattern-generating cells of the generator produces a pulse amplitude at the output terminal during a first calibrating operation,
wherein the sampling circuit of the calibration unit samples the pulse amplitude at output terminal during the first calibrating operation,
wherein the control circuit of the calibration unit supplies the bias circuit with a first calibration control signal responsive to an amplitude error with respect to a predetermined first reference value in sampling amplitude information of an output of the sampling circuit during the first calibrating operation,
wherein the plurality of pattern-generating cells of the generator produce a repeat pulse at the output terminal according to pull-up by the pull-up variable constant-current transistor and pull-down by the pull-down variable constant-current transistor during a second calibrating operation,
wherein the sampling circuit of the calibration unit samples a DC level of the output terminal just after the repeat pulse is produced during the second calibrating operation, and
wherein the control circuit of the calibration unit supplies the bias circuit with a second calibration control signal responsive to a DC level error with respect to a predetermined second reference value in sampling DC level information of the output of the sampling circuit, during the second calibrating operation.

2. The semiconductor integrated circuit according to claim 1,
wherein the bias circuit corrects a current value of at least one of the pull-up current and pull-down current of the plurality of pattern-generating cells of the generator in response to the first calibration control signal during the first calibrating operation.

3. The semiconductor integrated circuit according to claim 2,
wherein the bias circuit corrects imbalance of a current value of the other of the pull-up current and pull-down current of the plurality of pattern-generating cells of the generator with the current value of the one current in response to the second calibration control signal during the second calibrating operation.

4. The semiconductor integrated circuit according to claim 3,
wherein the control circuit is a voltage comparator which compares the sampling amplitude information of the sampling circuit with the predetermined first reference value, and compares the sampling DC level information of the sampling circuit with the predetermined second reference value.

5. The semiconductor integrated circuit according to claim 3,
wherein the control circuit includes an analog-to-digital converter for converting a voltage of the sampling amplitude information of the sampling circuit and a voltage of the sampling DC level information of the sampling circuit into respective digital signals.

6. The semiconductor integrated circuit according to claim 3,
wherein the second calibrating operation is executed after the first calibrating operation.

7. The semiconductor integrated circuit according to claim 3,
wherein the generator alternately and repeatedly produces a positive pulse having a positive peak trending from a DC voltage to a source voltage, and a negative pulse having a negative peak trending from the DC voltage to a ground voltage, thereby producing the transmit pulse.

8. The semiconductor integrated circuit according to claim 7,
wherein the generator includes a first generator and a second generator,
wherein one of the first and second generators produces a first pulse consisting of only positive pulses having positive peaks trending from the DC voltage to the source voltage at times ranked at even ordinal numbers in the plurality of times of the transmit pulse in response to a level of a transmit baseband signal,
wherein the other generator produces a second pulse consisting of only positive pulses having positive peaks trending from the DC voltage to the source voltage at times ranked at odd ordinal numbers in the plurality of times of the transmit pulse in response to the level of the transmit baseband signal, and
wherein the transmit pulse is produced by subtraction of one of the first and second pulses from the other.

9. The semiconductor integrated circuit according to claim 7,
wherein the generator includes a first generator and a second generator,
wherein one of the first and second generators produces a first pulse consisting of only negative pulses having negative peaks trending from the DC voltage to the ground voltage at times ranked at even ordinal numbers in the plurality of times of the transmit pulse in response to a level of a transmit baseband signal,
wherein the other generator produces a second pulse consisting of only negative pulses having negative peaks trending from the ground voltage to the source voltage at times ranked at odd ordinal numbers in the plurality of times of the transmit pulse in response to the level of the transmit baseband signal, and
wherein the transmit pulse is produced by subtraction of one of the first and second pulses from the other.

10. The semiconductor integrated circuit according to claim 7,
wherein the pull-up variable constant-current transistor and the pull-down variable constant-current transistor of each pattern-generating cell are a PMOS and an NMOS, respectively.

11. A method for operating an ultra wide band-impulse radio-transmitter implemented on a semiconductor integrated circuit, comprising:
a preparing step of preparing the ultra wide band-impulse radio-transmitter which produces a transmit pulse having an impulse waveform with predetermined amplitude values at a plurality of times at an output terminal during a transmitting operation;
a first step of executing a first calibrating operation;
a second step of executing a second calibrating operation; and
a third step of transmitting the transmit pulse having the impulse waveform with the predetermined amplitude values at the plurality of times after the first and second steps,
wherein the semiconductor integrated circuit comprises:
a generator including a plurality of pattern-generating cells for producing the transmit pulse; and
a calibration unit for calibrating the transmit pulse in amplitude and DC level fluctuation,
wherein the plurality of pattern-generating cells each include a pull-up variable constant-current transistor for passing a pull-up current through the output terminal, and a pull-down variable constant-current transistor for passing a pull-down current through the output terminal,
wherein the generator includes a bias circuit for supplying the pull-up variable constant-current transistor and pull-down variable constant-current transistor of each pattern-generating cell with a pull-up bias voltage and a pull-down bias voltage respectively,
wherein the calibration unit includes a sampling circuit for sampling a voltage at the output terminal, and a control circuit for controlling the pull-up and pull-down bias voltages from the bias circuit in response to an output from the sampling circuit,
wherein at least one of the plurality of pattern-generating cells of the generator produces a pulse amplitude at the output terminal during a first calibrating operation,
wherein the sampling circuit of the calibration unit samples the pulse amplitude at output terminal during the first calibrating operation,
wherein the control circuit of the calibration unit supplies the bias circuit with a first calibration control signal responsive to an amplitude error with respect to a predetermined first reference value in sampling amplitude information of an output of the sampling circuit during the first calibrating operation,
wherein the plurality of pattern-generating cells of the generator produce a repeat pulse at the output terminal according to pull-up by the pull-up variable constant-current transistor and pull-down by the pull-down variable constant-current transistor during a second calibrating operation,
wherein the sampling circuit of the calibration unit samples a DC level of the output terminal just after the repeat pulse is produced during the second calibrating operation, and
wherein the control circuit of the calibration unit supplies the bias circuit with a second calibration control signal responsive to a DC level error with respect to a predetermined second reference value in sampling DC level information of the output of the sampling circuit, during the second calibrating operation.

12. The method for operating an ultra wide band-impulse radio-transmitter according to claim 11,
wherein the bias circuit corrects a current value of at least one of the pull-up current and pull-down current of the plurality of pattern-generating cells of the generator in response to the first calibration control signal during the first calibrating operation.

13. The method for operating an ultra wide band-impulse radio-transmitter according to claim 12,
wherein the bias circuit corrects imbalance of a current value of the other of the pull-up current and pull-down current of the plurality of pattern-generating cells of the generator with the current value of the one current in response to the second calibration control signal during the second calibrating operation.

14. The method for operating an ultra wide band-impulse radio-transmitter according to claim 12,
wherein the control circuit is a voltage comparator which compares the sampling amplitude information of the sampling circuit with the predetermined first reference value, and compares the sampling DC level information of the sampling circuit with the predetermined second reference value.

15. The method for operating an ultra wide band-impulse radio-transmitter according to claim 13,
wherein the control circuit includes an analog-to-digital converter for converting a voltage of the sampling amplitude information of the sampling circuit and a voltage of the sampling DC level information of the sampling circuit into respective digital signals.

16. The method for operating an ultra wide band-impulse radio-transmitter according to claim 13,
wherein the second calibrating operation is executed after the first calibrating operation.

17. The method for operating an ultra wide band-impulse radio-transmitter according to claim 13,
wherein the generator alternately and repeatedly produces a positive pulse having a positive peak trending from a DC voltage to a source voltage, and a negative pulse having a negative peak trending from the DC voltage to a ground voltage, thereby producing the transmit pulse.

18. The method for operating an ultra wide band-impulse radio-transmitter according to claim 17,
wherein the generator includes a first generator and a second generator,
wherein one of the first and second generators produces a first pulse consisting of only positive pulses having positive peaks trending from the DC voltage to the source voltage at times ranked at even ordinal numbers in the plurality of times of the transmit pulse in response to a level of a transmit baseband signal,
wherein the other generator of the first and second generators produces a second pulse consisting of positive pulses having only positive peaks trending from the DC voltage to the source voltage at times ranked at odd ordinal numbers in the plurality of times of the transmit pulse in response to the level of the transmit baseband signal, and
wherein the transmit pulse is produced by subtraction of one of the first and second pulses from the other.

19. The method for operating an ultra wide band-impulse radio-transmitter according to claim 17,
wherein the generator includes a first generator and a second generator,
wherein one of the first and second generators produces a first pulse consisting of only negative pulses having negative peaks trending from the DC voltage to the ground voltage at times ranked at even ordinal numbers in the plurality of times of the transmit pulse in response to a level of a transmit baseband signal,
wherein the other generator of the first and second generators produces a second pulse consisting of only negative pulses having negative peaks trending from the ground voltage to the source voltage at times ranked at odd ordinal numbers in the plurality of times of the transmit pulse in response to the level of the transmit baseband signal, and
wherein the transmit pulse is produced by subtraction of one of the first and second pulses from the other.

20. The method for operating an ultra wide band-impulse radio-transmitter according to claim 17,
wherein the pull-up variable constant-current transistor and the pull-down variable constant-current transistor of each pattern-generating cell are a PMOS and an NMOS, respectively.
